(19) United States
(12) Patent Application Publication
(10) Pub. No.: US 2005/0009568 A1
(43) Pub. Date: Jan. 13, 2005

(54) Communication device having selectable voice message transmission

(76) Inventors: Zhipeng Hao, Buffalo Grove, IL (US); Lan Li, Buffalo Grove, IL (US)

Correspondence Address: MOTOROLA INC, 600 NORTH US HIGHWAY 45, ROOM AS437, LIBERTYVILLE, IL, 60048-5343, US

(21) Appl. No.: 10/616,343

(22) Filed: Jul. 9, 2003

(51) Int. Cl. H04M 1/00; H04B 1/38

(52) U.S. Cl. 455/563

(57) ABSTRACT

A communication device (100) and a method (400), enabling a user (202) of the communication device (100) to respond to a caller during a call with speech without speaking during the call, are provided. The communication device (100) stores selectable messages (204, 310, 312), and transmits a selected stored message during the call as a speech to the caller such that the caller hears a spoken message.

### FIELD OF THE INVENTION

The present invention generally relates to an apparatus and a method for a communication device, more specifically to an apparatus and a method for a communication device having a selectable voice transmission capability.

### BACKGROUND OF THE INVENTION

In certain situations, a user of a communication device such as a cellular telephone may not wish to, or may not be able to, vocally answer an incoming call. For example, the user may be in a meeting, or in a theatre, where speaking out loud would be disruptive to others in the area. The user may leave the area to another area where speaking is not disruptive to the others to answer the incoming call, or he may choose to have a voice mail answer the incoming call. If the user wishes to respond to the incoming call without speaking, he may determine the caller's identity by using an identification tool such as a caller ID program, terminate the incoming call, and then send a text message to the caller by initiating a separate communication. However, this process, requiring a separate communication channel and communicating with text, is awkward, and does not allow either party to hear the other party.

### BRIEF DESCRIPTION OF THE DRAWINGS

FIG. 1 is an exemplary block diagram of a communication device having selectable voice message transmission functionality in accordance with a first preferred embodiment of the present invention;

FIG. 2 is an exemplary diagram illustrating signal flow, message storage, and message display of the present invention;

FIG. 3 is an exemplary diagram illustrating the display showing three identifiers and brief descriptions for three voice messages;

FIG. 4 is an exemplary flow chart outlining the operation of the communication device in accordance with a second preferred embodiment of the present invention; and

FIG. 5 is an exemplary block diagram of a communication device having selectable voice message transmission functionality in accordance with a third preferred embodiment of the present invention.

### DETAILED DESCRIPTION OF THE PREFERRED EMBODIMENTS

The present invention provides an apparatus and a method for a communication device having selectable prestored messages which are transmitted as voice messages. For example, a user of the communication device, such as a cellular telephone, may select one of the prestored messages and play it in response to an incoming call instead speaking to the caller of the incoming call. In an environment where speaking is discouraged, such as a movie theater, the user is able to listen to the caller just as in a regular voice call with the present invention, and is also able to respond to the caller by selecting an appropriate message from the prestored messages, which is played to the caller as a voice message. The prestored messages may be prepared in various ways. For example, the user may record messages by speaking the messages. These spoken messages can then be digitized and stored in memory of the communication device. The user may also store text messages, and have a text-to-speech converter of the communication device convert a selected text message into a voice message when responding to the caller. The user may also initiate a call to another party with the present invention. For example, the user may first dial a desired telephone number, and when the call is answered, the user then may select and play a message, which the other party hears as a voice message.

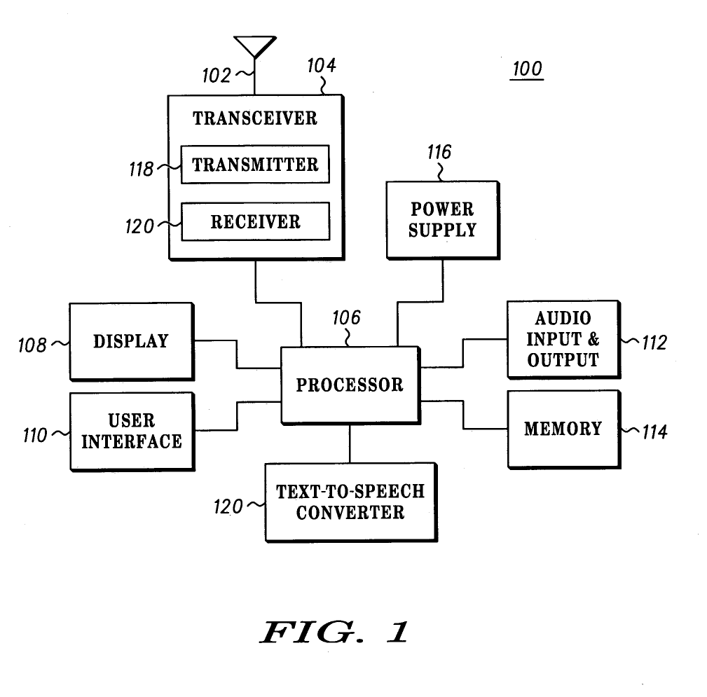

FIG. 1 is an exemplary block diagram of a communication device 100 having selectable voice message transmission functionality in accordance with a preferred embodiment of the present invention. The communication device 100 may be, but is not limited to, a radiotelephone such as a cellular phone or two-way radio, a paging device, a personal digital assistant (“PDA”), a handheld computer, a network browsing device, a tablet for a pen, a touchpad for a finger or a pen, a touch keypad for a finger, or any type of computing and/or communicating device capable of transmitting audio messages. The communication device 100 in FIG. 1 is illustrated as a cellular telephone, and includes an antenna 102, a transceiver 104, a processor 106, a display 108, a user interface 110, an audio input and output 112, a memory circuit 114, and a power supply 116, such as a battery, which is controlled by the processor 106, and provides power to the internal components so that they may function correctly.

Upon reception of wireless signals, the wireless communication device 100 detects the signals through the antenna 102 to produce detected voice and/or data signals. The transceiver 104, including a transmitter 118 and a receiver 120, coupled to the antenna 102, converts the detected signals into electrical baseband signals and demodulates the electrical baseband signals to recover incoming information, such as voice and/or data, transmitted by the wireless signals. After receiving the incoming information from the transceiver 104, the processor 106 formats the incoming information for output to the display 108 and/or audio input and output 112. Likewise, for transmission of wireless signals, the processor 106 formats outgoing information and conveys it to the transceiver 104 for modulation of a carrier and conversion into modulated signals. The transceiver 104 conveys the modulated signals to the antenna 102 for transmission to a remote transceiver (not shown).

Input and output devices of the wireless communication device 100 may include a variety of visual, audio and/or motion devices. The output devices may include, but are not limited to, the display 108 and the audio outputs such as speakers, alarms and buzzers of the audio input and output 112. The display 108 may include liquid crystal displays, light emitting diode indicators, or any other displays. The input devices may include, but are not limited to, the user interface 110 and audio inputs of the audio input and output 112. The user interface 110 may include keyboards, key pads, selection buttons, touch pads, touch screens, capacitive sensors, motion sensors, switches, or any other user inputs. The audio input of the audio input and output 112 may include a microphone or any other audio input. The memory circuit 114 may be used for storing and retrieving variety of data. The processor 106 may perform various operations to store, manipulate and retrieve information in the memory circuit 114. The communication device 100 may further include a text-to-speech converter 120, which is coupled to the processor 106, configured to convert a text to a speech.

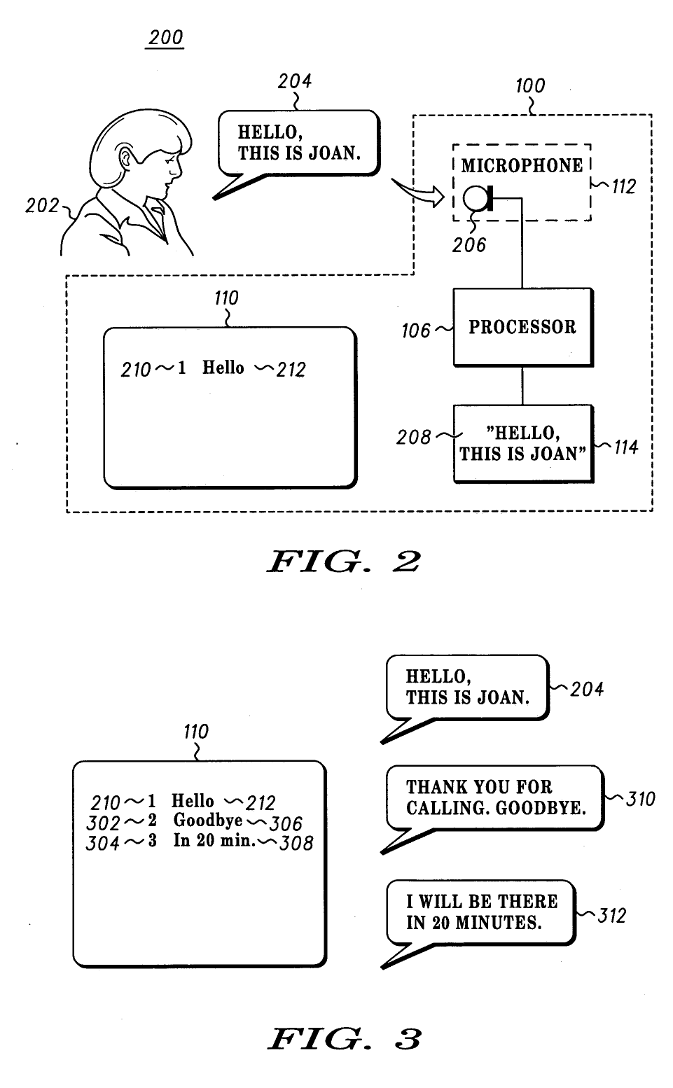

FIG. 2 is an exemplary diagram 200 illustrating signal flow, message storage, and message display of the present invention. A user 202 of the communication device 100 may record a spoken message 204 through a microphone 206 of the audio input and output 112. The processor 106 is configured to digitize the spoken message 204 and to store the digitized spoken message in the memory circuit 114 as a voice message 208. The processor 106 of the communication device 100 is also configured to accept input signals from the input keys of the user interface 110. A user of the communication device 100 may press one or more keys of the input keys of the user interface 110 to generate a user created identifier 210 identifying the corresponding voice message 208 in the memory circuit 114. The user 202 may also enter a brief description 212 of the voice message 208, and both the identifier 210 and the brief description 212 may be shown on the display 108.

FIG. 3 illustrates the display 108 showing three identifiers, 210, 302, and 304 and three corresponding brief descriptions 212, 306, and 308 as an example for three spoken messages 204, 310, and 312 as voice messages stored in the memory circuit 114. The first spoken message 204 “Hello, this is Joan” is stored as a voice message 208 in the memory circuit 114, and is identified as “1” with the first identifier 212 having a corresponding description of ‘Hello.’ The second spoken message “Thank you for calling. Goodbye.” is stored as a second voice message in the memory circuit 114, and is identified as “2” with the second identifier 306 having a corresponding description of ‘Goodbye.’ The third voice message “I will be there in twenty minutes.” is stored in the memory circuit 114, and is identified as “3” with third identifier 308 having a corresponding description of ‘In 20 min.’ The user 202 may select any of the voices messages by selecting an identifier corresponding to a desired voice message, and the voice message is transmitted by the transmitter 118.

The following is an illustrative example of the present invention usage enabling the user 202 and a caller to have a pseudo-conversation. The user 202 is in a movie theater and receives with the communication device 100 as described above having the voice messages 204, 310, and 312 an incoming call from the caller. Because the user 202 is in a movie theater, she wishes not to vocally answer the incoming call, yet she wishes to take the incoming call. With the communication device 100, she may communicate with the caller by first accepting the incoming call, then selecting the first voice message 208 by pressing the numeric key 1. The communication device 100 then transmits the first voice message 208 through the transmitter 118 to the caller, and the caller hears the first voice message 208 “Hello, this is Joan.” The user 202 is able to hear the caller without disturbing others around her by using the communication device 100, i.e., by placing the communication device to her ear, or she may use an earphone. The caller then asks the user 202 “Let me know when you will come out the theater, and I will meet you outside.” The user 202 then selects the third voice message by pressing the numeric key 3, and the caller hears the third voice message “I will be there in twenty minutes.” The user 202 then selects the second voice message by pressing the numeric key 2, and the caller hears the second voice message “Thank you for calling. Goodbye.” Then the user 202 terminates the call.

Messages to be stored in the memory circuit 114 are not limited to spoken messages. Text messages may be entered using the input keys of the user interface 110, and then be stored in the memory circuit 114. Each of the text messages may be similarly identified by an identifier and a brief description as described previously. The processor 106 may further be configured to convert a text message into a spoken message by functioning as a text-to-speech converter. If the user 202 selects a text message to be transmitted, then the processor generates a spoken message based upon the selected text message, and then transmits the generated spoken message through the transmitter 118. Alternatively, the communication device 100 may include a separate text-to-speech converter 120 as shown in FIG. 1.

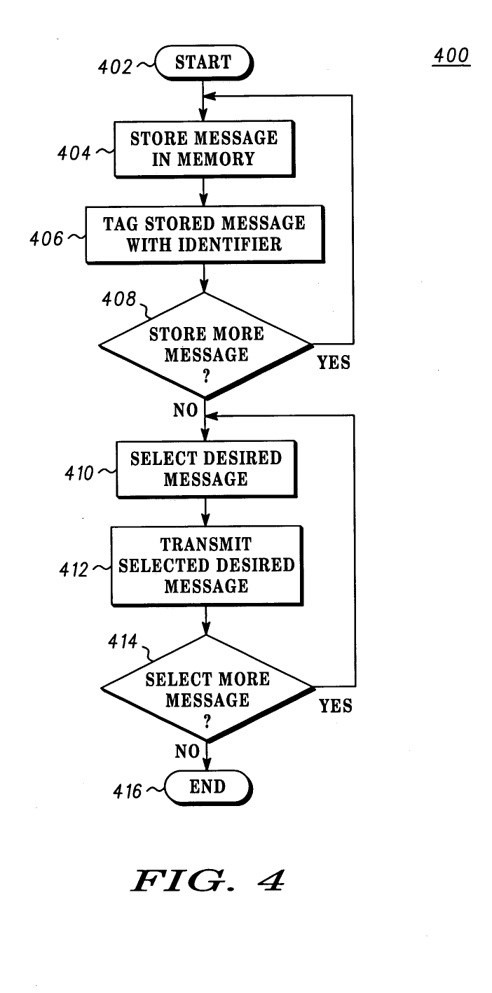

FIG. 4 is an exemplary flow chart 400 outlining the operation of the communication device 100 according to the present invention. The process begins in block 402, and then a desired message is stored in the memory circuit 114 in block 404. The desired message may be a text message entered through input keys of the user interface 110, or a spoken message recorded through the microphone 206. The stored message is then tagged with an identifier in block 406. Next, whether there is an additional message to be stored is checked in block 408. If there is, then the process repeats from block 404. If there is no more message to be stored, then a desired message from the stored messages is selected in block 410, and the selected desired message is transmitted in block 412. If the selected desired message is a text message, then the processor 106 converts the text message into a spoken message before it is transmitted in block 412. Then whether there is an additional message to be transmitted is checked in block 414. If there is, then the process repeats from block 410. If there is no more message to be transmitted then the process is terminated in block 416.

For preparing to respond to an incoming call, the user 202 is likely to go through blocks from 402 to 408 to store all anticipated responses in the memory circuit 114. Upon receiving a call between block 408 and 410, the user 202 is then able to select a desired response from the all stored responses, and is able to communicate with a caller with stored spoken messages that are either recorded voice messages of the user or synthesized speech by the processor 106 based upon the stored text messages.

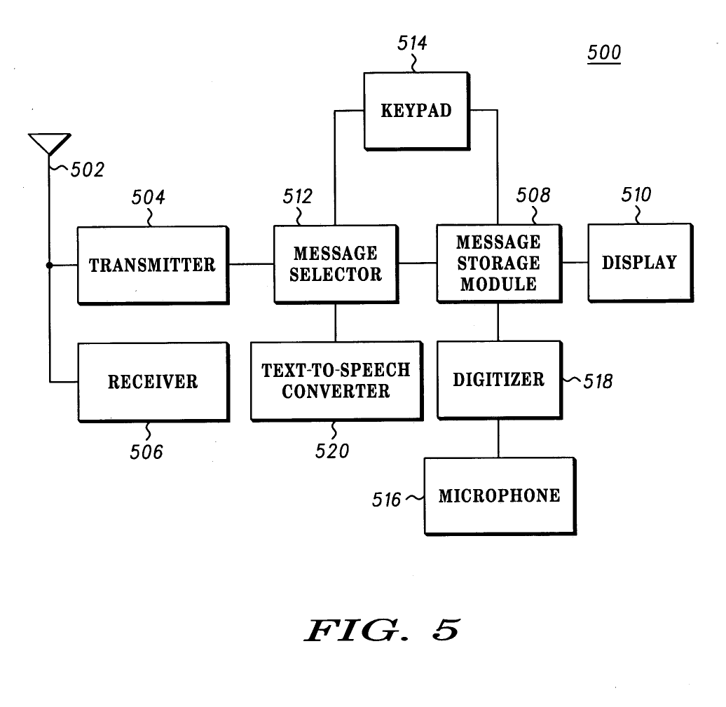

FIG. 5 is an exemplary block diagram of a communication device 500 having selectable voice message transmission functionality in accordance with a preferred embodiment of the present invention. The communication device 500 is illustrated as a wireless communication device comprising an antenna 502, a transmitter 504, a receiver 506, a message storage module 508, a display 510, a message selector 512, a keypad 514, a microphone 516, a digitizer 518, and a text-to-speech converter 520. The message storage module 508 stores a plurality of messages, each of which may be identified by a corresponding identifier. A stored message may be a spoken or text message. A spoken message may be captured by having a user speak into the microphone 516, digitizing the speech by the digitizer 518 to convert the speech into a digitized speech compatible with the message storage module 508, and storing the digitized speech in the message storage module 508. A text message may be entered by the keypad 514 and stored in the message storage module 508. The keypad 514 may also be used to generate identifiers for the stored messages. The display 510 is coupled to the message storage module 508 and displays a set of corresponding identifiers of the plurality of messages. The message selector 512 is coupled to the message storage module 508, and is configured to select a desired message of the plurality of messages by a corresponding identifier, which may be generated by the keypad 514. Once the desired message is selected, the transmitter 504 coupled to the message selector 512 transmits the selected desired message through the antenna 504. If the selected desired message is a text message, the text-to-speech converter 520 converts the selected text message to a voice.message before it is transmitted.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

1. A communication device, comprising:
a plurality of input keys, each of the plurality of input keys configured to generate a unique input key signal;
a processor coupled to the plurality of input keys, the processor configured to accept input key signals;
memory coupled to the processor, the memory configured to store a plurality of messages, each of the plurality of messages corresponding to and selectable by a unique identifier generated by at least one input key signal; and
a transmitter coupled to the processor, the transmitter configured to transmit a message selected from the plurality of messages by the at least one input key signal, the message transmitted as a voice message.

2. The communication device of claim 1, further comprising a microphone coupled to the processor, the microphone configured to receive a spoken message of a user, wherein the processor is further configured to digitize the spoken message to be stored in the memory as a voice message of the plurality of messages.

3. The communication device of claim 1, wherein the plurality of messages comprises a text message.

4. The communication device of claim 3, wherein the communication device further comprises a text-to-speech converter configured to convert the text message into a voice message before transmission.

5. The communication device of claim 1 further comprising a receiver coupled to the processor, the receiver configured to receive a call, wherein the processor is configured to convert the selected message into a voice message during the call before transmission of the selected message in response to the call.

6. The communication device of claim 1, further comprising a display configured to display the unique and selectable identifiers for the plurality of messages.

7. A method in a communication device for transmitting a voice message, the method comprising:
storing a message in memory;
identifying the stored message by at least one input key of a plurality of input keys of the communication device;
selecting the stored message by the at least one key; and
transmitting the selected stored message as a voice message.

8. The method of claim 7, wherein storing a message in memory comprises storing a digitized voice message of a user in memory.

9. The method of claim 7, wherein storing a message in memory comprises storing a text message in memory.

10. The method of claim 9, further comprising converting the text message into a voice message by utilizing a text-to-speech converter before transmitting the selected stored message.

11. The method of claim 7, further comprising:
receiving a call before selecting the stored message by the at least one key;
accepting the call in response to receiving the call; and
transmitting the selected stored message as a voice message during the call.

12. A method in a communication device for responding to a call by transmitting a voice message, the method comprising:
storing a plurality of messages in a memory;
uniquely identifying each of the plurality of messages in the memory;
receiving the call;
responding to the call by completing the call;
selecting one of the plurality of messages in the memory; and
transmitting the selected message as a voice message.

13. The method of claim 12, wherein the plurality of messages are stored in the memory by recording a plurality of spoken messages by a user.

14. The method of claim 12, wherein each of the plurality of messages in the memory are uniquely identified by assigning a unique tag to each of the plurality of messages, the unique tag comprising at least one input key stroke of a plurality of input keys of the communication device.

15. The method of claim 14, wherein selecting one of the plurality of messages in the memory comprises entering at least one input key stroke of the plurality of input keys of the communication device corresponding to a unique tag assigned to a desired message of the plurality of message in memory.

16. The method of claim 14, further comprising:
displaying a set of the plurality of messages including unique tags on a display; and
selecting one of the displayed messages by inputting the corresponding unique tag with at least of the plurality of input keys.

17. A communication device, comprising:
a message storage module configured to store a plurality of messages, each of the plurality of messages having a corresponding identifier;
a display coupled to the message storage module, the display configure to display a set of corresponding identifiers of the plurality of messages;
a message selector coupled to the message storage module, the message selector configured to select a message of the plurality of messages by a corresponding identifier; and
a transmitter coupled to the message selector configured to transmit a selected message.

18. The communication device of claim 17, further comprising:
a microphone configured to accept a spoken message; and
a digitizer coupled to the microphone and to the message storage module, the digitizer configured to convert the spoken message into a digitized data compatible with the message storage module.

19. The communication device of claim 17, further comprising a keypad coupled to the message storage module and to the message selector, the keypad configured to generate a text message to be stored in the message storage module and to generate identifiers for the plurality of messages, the keypad further configured to accept an identifier used by the message selector.

20. The communication device of claim 19, further comprising a text-to-speech converter coupled to the message selector, the text-to-speech converter configured to convert a selected text message to a voice message.
